(19) United States
(12) Patent Application Publication
(10) Pub. No.: US 2009/0157522 A1
(43) Pub. Date: Jun. 18, 2009

(54) ESTIMATING VEHICLE PRICES USING MARKET DATA

(76) Inventors: Arun Srinivasan, Mumbai (IN); Girish Kamble, Mumbai (IN); Amit Bhartiya, Mumbai (IN)

Correspondence Address: SCHWEGMAN, LUNDBERG & WOESSNER/EBAY, P.O. BOX 2938, MINNEAPOLIS, MN, 55402, US

(21) Appl. No.: 12/259,955

(22) Filed: Oct. 28, 2008

Related U.S. Application Data
(60) Provisional application No. 61/014,555, filed on Dec. 18, 2007.

(51) Int. Cl. G06Q 30/00; G06Q 50/00

(52) U.S. Cl. 705/26

(57) ABSTRACT

Prices may be estimated using a system comprising a data exporter to export auction transaction data from an online auction system; a data processor to filter, condition, aggregate, and/or model the auction transaction data; and a data presenter to present the filtered, conditioned, aggregated, and/or modeled auction transaction data indicating estimated prices based on the auction transaction data. Additional apparatus, systems, and methods are disclosed.

### RELATED PATENT DOCUMENTS

This patent application claims the benefit of priority, under 35 U.S.C. Section 119(e), to U.S. Provisional Patent Application Ser. No. 61/014,555, entitled “ESTIMATING VEHICLE PRICES USING MARKET DATA,” filed on Dec. 18, 2007, the contents of which are hereby incorporated by reference in its entirety.

### BACKGROUND

The Internet has become a widely-accepted tool for many financial transactions, including markets that are conducted for buying and selling vehicles.

### BRIEF DESCRIPTION OF THE DRAWINGS

Some embodiments are illustrated by way of example and not limitation in the figures of the accompanying drawings in which:

FIG. 1 is a schematic diagram illustrating a network system having a client-server architecture, according to an example embodiment;

FIG. 2 is a block diagram illustrating multiple marketplace applications that, in an example embodiment, are provided as part of a network-based marketplace;

FIG. 3 is a data flow diagram of a network system, according to an example embodiment;

FIG. 4 is a block diagram illustrating portions of a system to process data and estimate vehicle prices, according to an example embodiment;

FIG. 5 is a flow chart illustrating a method, according to an example embodiment, of using auction data to estimate vehicle prices;

FIG. 6 is a flow chart illustrating a method, according to an example embodiment, of presenting an estimated vehicle price;

FIGS. 7-16 are diagrams illustrating a variety of graphical user interfaces (GUIs), according to example embodiments; and

FIG. 17 is a block diagram of a machine in the form of a computer system within which a set of instructions, for causing the machine to perform any one or more of the methodologies discussed herein may be executed, according to an example embodiment.

### DETAILED DESCRIPTION

Example methods, apparatus, and systems to estimate pricing, including used vehicle pricing, will now be described. In the following description, for purposes of explanation, numerous specific details are set forth in order to provide a thorough understanding of example embodiments. It will be evident, however, to one skilled in the art that various embodiments may be practiced without these specific details. For example, while the apparatus, systems, and methods described herein are directed to the pricing of vehicles, these mechanisms can be applied to any number of other items that are bought and sold in online markets.

The used car market is a huge enterprise including hundreds, if not thousands, of dealerships, banks, insurance companies, wholesalers, liquidators, and auction houses. Generally, when a used vehicle is traded in or sold to a dealership, the dealership has to decide whether to retail the used vehicle on one of their own lots or to sell the vehicle in a secondary market. Should the dealership decide to sell the vehicle in the secondary market, the vehicle may be sold at an auction, which may be held exclusively for other dealers. Vehicles are typically sold at wholesale prices by sellers, such as dealerships, fleet operators, banks, and insurance companies, to buyers, which are typically other dealerships that ultimately seek to resell the vehicle to a retail customer.

In the past, the secondary market auctions were conducted using a live auctioneer at a physical location. In the electronic age, online auction systems have arisen to replace the live auctioneer, so that the auction location can be removed from a physical location to a virtual online marketplace designed to include participants from all over the country, or all over the world.

Because of the computerized nature of electronic online auction systems, data collection becomes more accurate and more immediately available. As such, data collection and analysis may be performed soon after an auction has been completed with little or no loss of data integrity or data accuracy—as opposed to collecting data from live auctions where the data may be incomplete, misinterpreted, mis-keyed during data entry, or otherwise suspect or inaccurate.

Using various statistical modeling and data presentation techniques, collected data may be used to present accurate, up-to-date information to all types of users. For example, a user (e.g., a dealership) may wish to research the current wholesale price of a particular vehicle for an auction in progress. As another example, an end customer may wish to research a similar price to determine how much over wholesale the retail price represents to position themselves in a potential purchase. As yet another example, an institutional buyer (e.g., a fleet operator) may wish to research the depreciation of a particular model or vehicle class to determine whether future purchases of a similar model or vehicle class make financial sense.

In an example embodiment, vehicle data collected from completed online auctions is used to estimate current values of similar vehicles. The estimated current values may be presented to a user in various ways, such as in an online presentation (e.g., a web page), a written record (e.g., a book, magazine, or pamphlet), an electronic message (e.g., an email, Short Message Service (SMS) message, or instant message), or by other means (e.g., voice mail, voice over IP). The estimated current values may include calculated depreciated values, wholesale values, retail values, insurance replacement values, or other estimates reflecting the value of a vehicle. In addition, the estimated current values may provide an indication of historical or predicted future price trends. The estimated current values for a particular vehicle may be presented alongside value representing estimated (or actual) current values of a comparison vehicle or several comparison vehicles, such as vehicles in a related market segment (e.g., sport sedans, sport utility vehicles, compact cars).

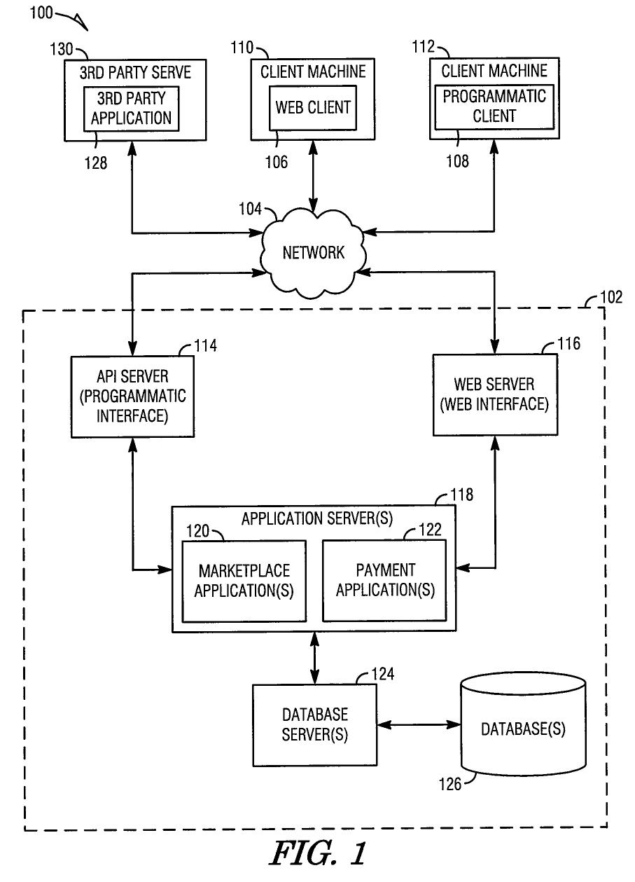

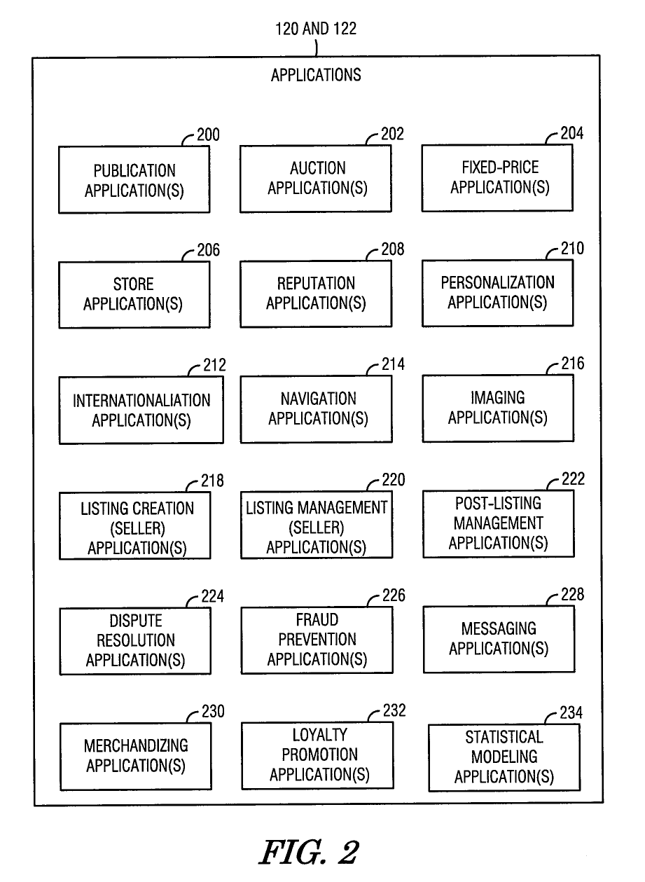

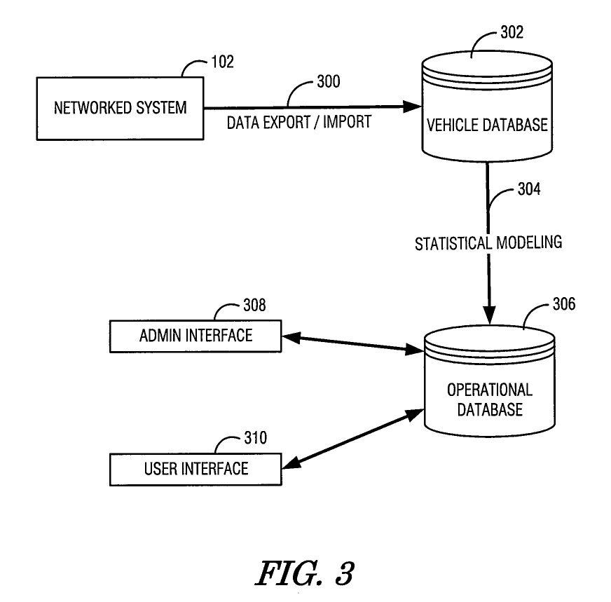

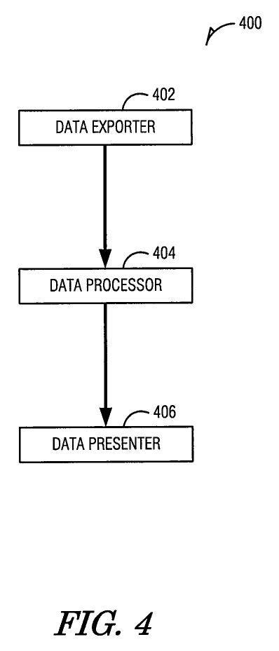

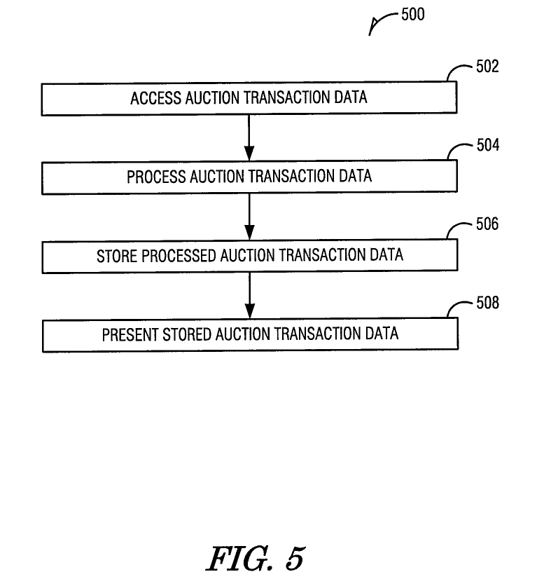

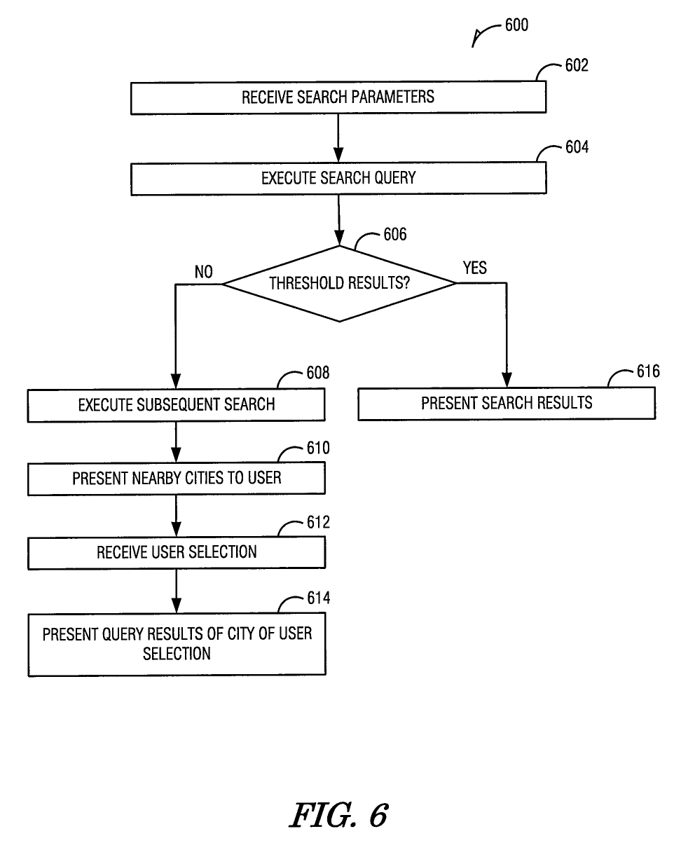

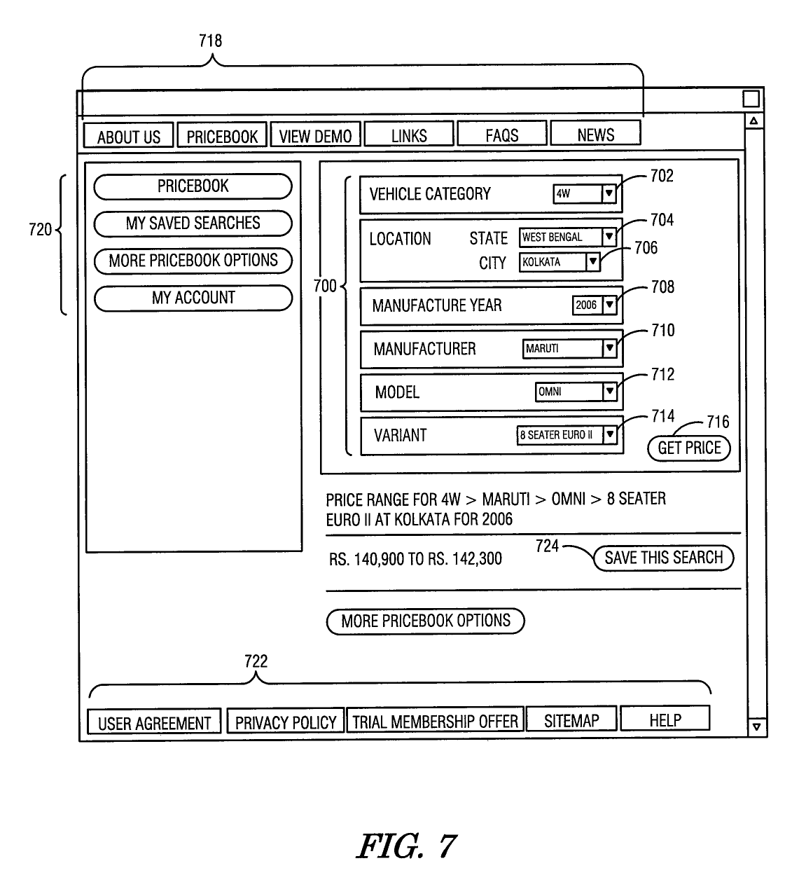

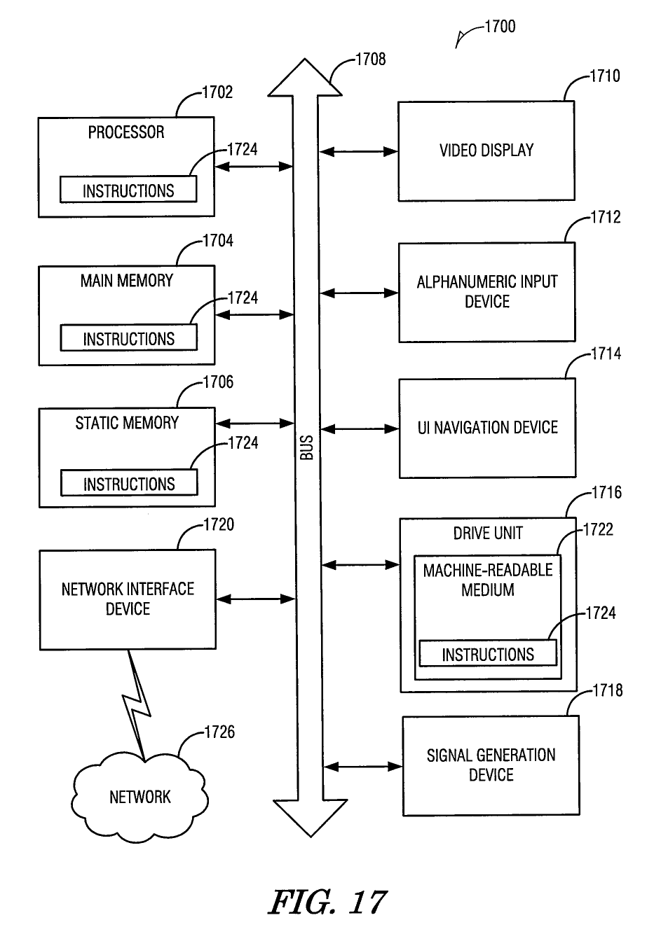

The following sections include a description of a platform for conducting vehicle auctions (FIG. 1), marketplace and payment applications (FIG. 2), data processing flow for vehicle auction information (FIG. 3), a system for performing the data processing (FIG. 4), flowcharts of methods for managing vehicle auction information (FIGS. 5 and 6), user interface diagrams (FIGS. 7-16), and a machine diagram (FIG. 17).

### Platform Architecture

FIG. 1 is a schematic diagram illustrating a client-server system 100, within which various embodiments may be deployed. A networked system 102, in the example forms of a network-based marketplace or publication system, provides server-side functionality, via a network 104 (e.g., the Internet or Wide Area Network (WAN)) and one or more clients. FIG. 1 illustrates, for example, a web client 106 (e.g., a browser, such as the Internet Explorer® browser developed by Microsoft® Corporation of Redmond, Wash.) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the various embodiments are not limited to such an architecture, perhaps finding application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, comprise a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

In an example embodiment, a storage device (e.g., database 126) is configured to store data related to a vehicle auction transaction. A control device (e.g., web server 116, application server 118, database server 124, or client machine 110) may be communicatively coupled to the storage device and adapted to access the vehicle auction transaction data from the storage device; process the vehicle auction transaction data to estimate a vehicle price; store the vehicle price in the storage device; and present the vehicle price on a display device.

### Marketplace Applications

FIG. 2 is a block diagram illustrating multiple marketplace and payment applications 120 and 122 that, in an example embodiment, are provided as part of the networked system 102. The applications 120 and 122 may be hosted on dedicated or shared server machines (not shown) that are communicatively coupled to enable communications between the machines. The applications 120 and 122 themselves are communicatively coupled (e.g., via appropriate interfaces) to each other and to various data sources, so as to allow information to be passed between the applications and/or to allow the applications to share and access common data. The applications 120 and 122 may furthermore access one or more databases 126 via the database servers 124.

Referring now to FIGS. 1 and 2, it can be seen that the networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, using the networked system 102, and to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or inventory data structures according to which listings may be classified within the networked system 102. Various other navigation applications may be provided to supplement the search and browsing applications.

In order to make listings available via the networked system 102 visually informing and attractive, the marketplace applications 120 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to offer for sale via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages for example advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that engage in transactions via the networked system 102, may operate loyalty programs that are supported by one or more loyalty/promotions applications 232. For example, a buyer may earn loyalty or promotions points for each transaction established and/or concluded with a particular seller, and be offered a reward for which accumulated loyalty points can be redeemed.

Statistical modeling applications 234 support various data manipulation and organization processes. In an embodiment, estimated prices of auction items, such as vehicles, may be calculated using one or more applications from the statistical modeling applications 234. The statistical modeling applications 234 may implement various techniques, such as linear regression analysis and mean analysis using standard deviation. As an example, by analyzing past transactions, a statistically-based estimated market price for currently-available items may be established and presented to potential buyers in a commerce system to assist the buyers when making decisions about purchasing or bidding.

### Data Flow

FIG. 3 is a data flow diagram illustrating data and control flow within a network system, according to an example embodiment. Auctions for vehicles can be conducted using the networked system 102. Auctions may include various vehicle types, such as cars, trucks, sports utility vehicles, two-wheel vehicles (e.g., motorcycles), commercial vehicles, construction vehicles and equipment, three-wheel vehicles, and tractors. In an embodiment, used vehicle price data is the outcome of online auctions of vehicles with registered dealers vying for each vehicle.

At 300, data is exported from the networked system 102 and imported into a vehicle database 302. Data may be exported from the networked system 102 using various methods, such as a comma separated value (CSV) file, a database replication operation, a database query, or formatted data output (e.g., using eXtended Markup Language (XML)). The data export/import operation 300 may include sub-operations, such as checks for data consistency, data formatting or conditioning, and data normalization (e.g., removing outlier data points). Data exporting may be performed at regular or periodic intervals, or on-demand, in various embodiments.

In an embodiment, the vehicle database 302 may be configured to store data related to vehicles auctioned in the networked system 102, general vehicle information (e.g., make, model, year, type, options), and historical vehicle information. The vehicle database 302 may also be configured to store auction-related vehicle information, such as a start date and time, an end date and time, a starting price, a final price, a reserve price, a number of bids, a number of bidders, financing terms, a seller, or a buyer.

Using the data stored in the vehicle database 302, a statistical modeling operation 304 is conducted to calculate prices of vehicles included in the vehicle database 302. The statistical modeling operation 304 may perform various operations, such as aggregating or organizing price data across a market segment, calculating price ranges for model variants, or calculating prices based on other factors, such as vehicle location, age, taxes, depreciation, condition, and options. The calculated price data is stored in the operational database 306 to be accessed by administrative users via the admin interface 308, or end users via the user interface 310.

Administrative users may control various aspects of the end user's user interface 310, such as the availability or configuration of user interfaces, graphical output (e.g., chart, graph, matrix, formatted list), or data subsets. As an example of controlling data subsets, an administrative user may initially limit an end user's access to only four-wheel vehicles. Additional access to three-wheel vehicles may be available at an additional cost. When the end user opts to pay the additional cost, the administrative user may update the configuration of the end user's user interface 310 to display the additional content. Similarly, other data subsets may be presented or withheld from an end user. For example, some model years may be available for an extra charge or a premium subscription. As another example, a basic service may only provide individual pricing estimates, while a higher-level service may provide estimates of several vehicles for comparison in a formatted output.

The user interface 310 need not be limited to an electronic medium. In various embodiments, the user interface 310 includes a printed publication (e.g., a magazine, letter, pamphlet, booklet, etc.), an Internet-based application (e.g., a website, a phone-based application (e.g., a toll-free number), or a mobile-based solution (e.g., SMS messaging, mobile web access). In an embodiment, the user interface 310 may be configured to provide more then one method of accessing the available information. For example, a user may access vehicle information via a subscriber website in addition to regular updates via a monthly newsletter.

FIG. 4 is a schematic diagram illustrating portions of a system 400, according to an example embodiment, to process data and estimate vehicle prices according to the data processing flow illustrated in FIG. 3. A data exporter 402 exports auction transaction data. The data exporter 402 may include, be a component of, or be equivalent to the networked system 102, as illustrated in FIG. 3, in various embodiments. A data processor 404 processes the auction transaction data. Various statistical, mathematical, arithmetical, or organizational data manipulation may be performed by the data processor 404 to transform the exported data. Some examples of such operations are described above with reference to the statistical modeling operation 304. For example, the data processor 404 may filter, condition, aggregate, or model the auction transaction data, in various embodiments. A data presenter 406 accesses the data processed by the data processor 404 and presents it to a user. The data presenter 406 may include, be a component of, or be equivalent to the user interface 310, in various embodiments.

### Methods

FIG. 5 is a flow chart illustrating a method 500, according to an example embodiment, of using auction data to estimate vehicle prices. At 502, auction transaction data is accessed. The auction transaction data may include auction information, vehicle information, or transaction information, in various embodiments. Auction information may include listing information, initial auction price, auction closing price, transaction costs, and other information related to in-progress, closed, completed, or abandoned vehicle auctions. Vehicle information may be obtained from one or more database records that describe a previously-conducted auction for a used commercial vehicle. The database records may include vehicle characteristics, such as mileage, condition, vehicle manufacturer, make, model, variant, trim, engine, options, and the like. In addition, the database records may include transaction information related to the listing, such as a seller, a buyer, an initial auction price, a closing price, a reserve price, a bid history, a tax, a transaction surcharge, or other transaction costs. The data records may be stored in various formats, such as an relational database, an object oriented database, a flat file database, a spreadsheet, a comma delimited value file, a structured file (e.g., an extensible markup language (XML) file), and other storage formats.

At 504, auction transaction data is processed. Processing may include several actions, such as filtering, conditioning, aggregating, and modeling. In an embodiment, the filtering process may be implemented to remove outlying data points - those data points that are statistical anomalies - to improve statistical accuracy. The acceptable range of data, such as the sale price of a vehicle, may be statistically determined or optionally, is manually or semi-manually configurable. In an embodiment, the filtering process may be implemented to selectively retain or exclude data based on an auction characteristic. For example, a database may be designed for a particular geographic region (e.g., a country or state), such that the filtering process is implemented to retain data for auctions that were conducted with a seller and/or buyer in the particular geographic region. In an embodiment, the filtering process may be implemented to selectively retain or exclude data based on a vehicle characteristic. For example, a database may be designed exclusively for commercial vehicle auctions. As such, recreational, non-commercial, and consumer-oriented vehicle listings or auctions may be excluded from the commercial vehicle database.

In an embodiment, the conditioning process may be implemented to check for data consistency and format data to adhere to a consistent usage. For example, string values may be truncated or padded to fit a fixed-field size. As another example, currencies may be revised to represent a particular common currency based on an exchange rate (e.g., the exchange rate at the time of the end of the auction).

In an embodiment, the aggregation process may be implemented to combine auction transaction data. For example, similar or related auction transaction data may be aggregated before statistical modeling is performed. This may be done for several reasons, such as, to gather enough sample points to make a statistically relevant data point or result, compare logical divisions or groupings to one another, or to normalize data groups.

In an embodiment, the modeling process may be implemented to perform one or more statistical operations on the auction transaction data. For example, linear or exponential regression, or mean analysis may be used to determine an estimated price, price plot, or price range of a vehicle. Estimated prices may include past, present, or future values or prices. Other types of statistical operations, such as logarithmic decay to estimate depreciated residual values, extrapolation to estimate future value, or interpolation to estimate missing or underrepresented intermediate data points, may be applied, for example.

In an example embodiment, whether regression analysis is performed or mean analysis is performed depends on two factors: the number of data points and a threshold value. First, the number of data points representing past sales that are available for a selected vehicle make, vehicle model, vehicle variant, and location (e.g., city) combination is obtained. In an example embodiment, a number of data points of vehicle sales of a vehicle similar to the selected vehicle are also determined. Then, using a threshold value, either regression (e.g., linear or exponential) is used or mean analysis is used to estimate a vehicle price.

If regression is used, then in an example embodiment, another filter is applied to check the validity of the regression technique. As an example, a standard technique, such as the “F-Test” may be used to assess the overall validity of the regression model. If the test indicates that the model is valid, then regression is used; otherwise, a mean analysis is used to estimate the vehicle price.

The output of the processing (block 504) may include an estimate of a past, present, or future vehicle price, in various embodiments. The output may be expressed as a range. Additionally, the output may be expressed as a single value with associated upper and lower limits defining a range of confidence. For example, an estimated future price of a used vehicle may be expressed as 45,000 rupees (“Rs.”), ±3,000 Rs., where 3,000 Rs. is the confidence interval.

At 506, the processed auction transaction data is stored. The processed data may be stored in one or more databases. Databases may include relational database, flat file databases, spreadsheets, and the like. Processed data may also be stored in a non-electronic form, such as a booklet, pamphlet, or other physical medium. The processed data may be stored in a raw state (e.g., unprocessed data), in an intermediate state (e.g., partially processed data), or a final state (e.g., fully processed data), or any combination of states. Storing data in a partially or fully-processed state may reduce data access latency; however, some data transparency may be lost.

At 508, the processed auction transaction data is presented. In an embodiment, the auction transaction data is used to provide several different vehicle prices, such as an estimated present and future price. Presentation of the processed auction transaction data may take one of several forms, including electronic presentation (e.g., a webpage, a text message, an email, or a voice mail), physical presentation (e.g., a magazine, a newsletter, a book, a pamphlet, or a flyer), or a transmission media (e.g., a live phone call, a radio broadcast, or a cellular broadcast). In an embodiment, a vehicle price is presented using a first plot in a line graph and a second, comparable vehicle is presented using a second plot in the line graph. The line graph may be presented using the various mediums described.

In an embodiment, the data is presented in one or more web pages using graphical elements, such as charts, graphs, or tables. For example, a line graph may be used to illustrate the estimated price of a vehicle over time, e.g., over several model years. As another example, a line graph may be used to illustrate an estimated price of a vehicle and an estimated depreciated residual price over time, e.g., several model years. As other examples, the prices of two or more vehicles, or the estimated depreciated residual prices of two or more vehicles may be displayed for comparative analysis.

The vehicles and/or the depreciated residual prices may be selected, configured, or adjusted by a user, in various embodiments. For example, the user may select a first vehicle and view auction-generated price data associated with the first vehicle. The user may then select one or more additional vehicles to view alongside or in conjunction with the first vehicle's information. In addition, the user may then add depreciated residual information for the first vehicle and/or one or more of the additional vehicles. An example of a user-available adjustment may include a user-selectable depreciation rate (e.g., input by the user using a drop down list, a text field, or other user interface control). Other embodiments of graphical elements are illustrated in FIGS. 7-16, which illustrate screen shots of a user interface.

FIG. 6 is a flow chart illustrating a method 600, according to an example embodiment, of presenting an estimated vehicle price. At 602, one or more parameters are received. In an embodiment, the parameters are received from a user, such as within a browser-based user interface. In an embodiment, the parameters are received in a file or other formatted input (e.g., an XML document or stream) from an automated or semi-automated process. The parameters may include various criteria defining a search request or a search query to be used to search a vehicle database. For example, the parameters may be formatted to include “4W,” “Honda,” “Accord,” “1999,” “Andhra Pradesh,” and “Eluru,” where “4W” indicates a vehicle platform (four-wheel vehicles), “Honda” indicates a vehicle manufacturer, “Accord” indicates a vehicle model, “1999” indicates a model year, and the combination of “Andhra Pradesh” and “Eluru” indicate a price locality of interest. In this example, the requester is providing a search request for an estimated price for a 1999, Honda® Accord®, sold in Eluru, Andhra Pradesh, India.

At 604, a search query is executed. The search query may use one or more parameters provided at 602. In addition, other parameters may be included in the search query. Other parameters may be derived or retrieved from the environment. For example, the search query may be configured using environmental variables available in an online context, such as an internet browser environmental variable, session variable, cookie value, account setting, or the like.

At 606, search results are analyzed to determine whether a threshold number of results were found. The threshold may be configurable by an administrative user or the end user, in various embodiments. For example, if there are a low number of data points, statistical variation may render any estimated price meaningless; however, an end user may wish to view the calculated result, knowing that the minimal number of data points will affect the outcome and may render the data suspect or useless. In such a case, the user may configure the threshold to be very low, such as one or zero, in order to obtain results even when the results may lack statistical foundation.

At 608, if less than the threshold number of results were found, then a subsequent search is performed using a variant of the search parameter. In an embodiment, the variant of the search parameter may include cities or regions that are considered “nearby” or in “close proximity”. The distance used to determine whether a city or region is “nearby” or in “close proximity” may be configurable. As an example, a proximity setting may be used to determine which cities are considered in “close proximity.” The proximity setting may be represented as a distance value, such as 100 kilometers, as a regional boundary, or a combination of a distances and boundaries.

To continue the example from above, the subsequent search may determine that enough data points exist for the particular vehicle (e.g., Honda® Accord®) in nearby Hyderabad, Andhra Pradesh. As a continuing example, the subsequent search may also determine that another nearby city, Vijayawada, does not have a sufficient number of data points to provide an estimated price. As yet another example, the subsequent search may determine that although no Honda® Accords® are available as price data points in a nearby city, there are similar vehicles, such as Toyota® Carmy® of a similar year and equipment package. The subsequent search may then produce the Toyota® Carmy® as a comparable vehicle.

To determine comparable vehicles to use in a subsequent search, in an example embodiment, an aspect of a vehicle associated with the initial search parameter is determined. Then, one or more similar vehicles based on the aspect of the vehicle associated with the initial search parameter are identified. These similar vehicles may then be used as the variant of the search parameter. In various embodiments, the aspect of the vehicle associated with the initial search parameter includes one or more of a vehicle classification, a vehicle type, a vehicle model, a vehicle trim, a vehicle segment, a vehicle use, a vehicle competitor, a vehicle price range, or vehicle options.

One or more aspects of the subsequent search may be configurable, in various embodiments. For example, a threshold distance away from the initial city of interest may be configured such that cities that are farther than the threshold distance are not considered “nearby” or in “close proximity” for the purposes of the subsequent search. As another example, nearby cities may be restricted to a particular geographic boundary, such as a state or region. By restricting nearby cities to the same region or state, the subsequent search may improve or maintain statistical accuracy or meaningfulness. For example, if vehicle prices vary dramatically in a nearby state due to local taxes or other costs, then even if two cities are within a short distance from each other, if they are in different states, then they may not be statistically relevant to each other for comparative analysis.

In addition, whether a search is conducted in nearby cities for similar vehicles may be configurable, in some embodiments. Another configurable aspect may include a “similarity control” (e.g., how similar vehicles need to be to each other to be included in the subsequent search) or which vehicles are considered similar to each other. For example, similar vehicles may be predetermined (e.g., by a system designer) or may be selected by the user. As an illustration, while some vehicles may have direct competitors (e.g., Honda® Accord® and Toyota° Camry®) and may be recognized as similar vehicles by predetermined configuration, other vehicles may not be pre-classified, but similar enough for a user to be interested in viewing such vehicles in a combined output. As an example, a pickup truck and a sports utility vehicle may not be pre-classified as being similar, but they both may satisfy a particular need of the user (e.g., towing cargo), and as such, the user may be interested in viewing price data for each vehicle.

At 610, the user is provided with search results of the subsequent search. For example, one or more nearby cities that have sufficient data to present an estimated price for the vehicle of interest are presented. The cities may be presented using graphical interface elements, such as hyperlinks, graphical buttons, or other dynamic interface elements.

In an embodiment, one or more locations are presented, such that each location corresponds to a subset search result in the second search result. For example, when Hyderabad and Vijayawada both have relevant search results, they may be presented to the user. The user may then select a location, such as by activating a hyperlink in a online GUI. The search results corresponding to the user-selected location are then presented. The location may be based on a city, state, region, or province in various embodiments.

At 612, the user's choice is received. The user may indicate a choice by clicking on or otherwise activating a hyperlink, for example.

At 614, the chosen location is displayed with the price estimate according to the search query's parameters. By displaying prices in nearby cities, the user is able to obtain a better understanding of what the estimated price of the vehicle of interest may be in the initial city of interest (e.g., Eluru in the continuing example).

At 616, when at least a threshold number of results are found, the search result is presented to the user.

In an embodiment, the subsequent search may be run even when the threshold number of results is found, and results for nearby cities may be presented along with the initial city for comparison. Vehicle prices for the vehicle associated with the initial search or a vehicle associated with the subsequent search may be displayed using a chart, graph, table, or other graphical element.

As another example embodiment, subsequent searches may also be performed by changing the model year. For example, if a price for a 2005 Honda® Accord® is not available in Eluru, but a price is available for a 2004 Honda® Accord® in Eluru, the price for the 2004 model may be provided to the user.

### User Interfaces

FIGS. 7-16 are diagrams illustrating a variety of GUIs, according to example embodiments.

FIG. 7 illustrates a plurality of search parameter controls 700, including a vehicle category search control 702, a state control 704, a city control 706, a manufacture year control 708, a manufacturer control 710, a model control 712, and a variant control 714. In general, the GUI may receive values from users via the plurality of search parameter controls 700 to establish parameters for a search query. When the user is satisfied with the search boundaries or parameters, the search may be initiated using the submission control 716. In the example shown in FIG. 7, the user has selected criteria to form search parameters and executed the search, resulting in an estimated price range of 140,900 rupees (“Rs.”) to 142,300 Rs. While the example shown includes references to the currency of India, the rupee, it is understood that any currency or other measurement of value may be used.

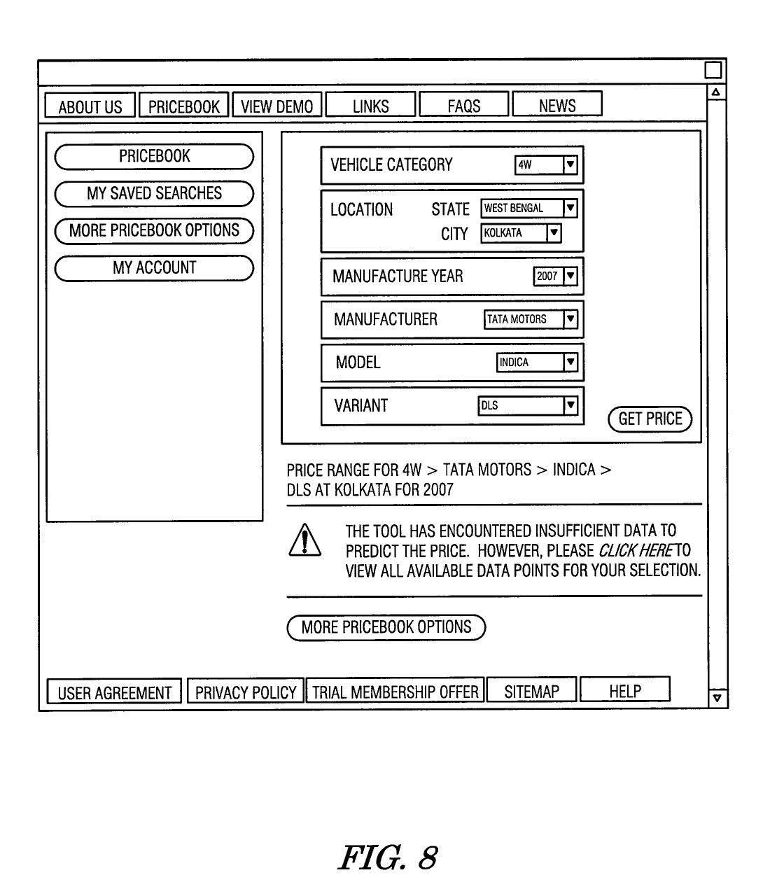

FIG. 7 also illustrates other navigational controls, including a navigational header bar 718, a navigational sidebar 720, and a navigational footer bar 722. The navigational controls may be repeated throughout the user interface to provide a consistent look and feel by providing familiar placement of the navigational controls to the user. It should be noted that although the navigational controls are not illustrated in the other user interface figures (e.g., FIGS. 8-16), it is understood that they may also be incorporated or reproduced in these user examples to provide an overall coherent user interface, as desired.

In the example shown, the navigational header bar 718 includes hyperlinks to informational sections, such as “About Us,” “FAQs,” and “News.” The navigational footer bar 722 includes hyperlinks to legal disclaimers and agreements, along with other informational sections to provide help or overview of the site's operation. By using the controls in the navigational sidebar 720, the user may access the “Pricebook”, saved searches, additional Pricebook options, and the user's account. In an embodiment, basic functionality is available using the “Pricebook” interface, while advanced functionality is available using the “More Pricebook Options” interface (to be discussed below). The advanced functionality available in the “More Pricebook Options” interface may be selectively available to premiere customers or select users.

In addition, FIG. 7 also includes a “Save this Search” control 724, which when activated, saves the search parameters and the search result. The user may access saved searches by activating the “My Saved Search” control in the navigational sidebar 720. Searches may be saved and associated with the user for various time periods, for example, for the duration of the current browser session, for a fixed period of time (e.g., two weeks), or until the user deletes them from the saved searches.

FIG. 8 illustrates an example user interface provided to a user when there are an insufficient number of data points to predict or estimate a price. In the example shown in FIG. 8, the user is presented the option to view all available data points resulting from the search query. By viewing the actual data points available, the user is allowed to draw their own conclusion about an estimated price. The available data points may be presented in a chart, list, graph, or other organized output.

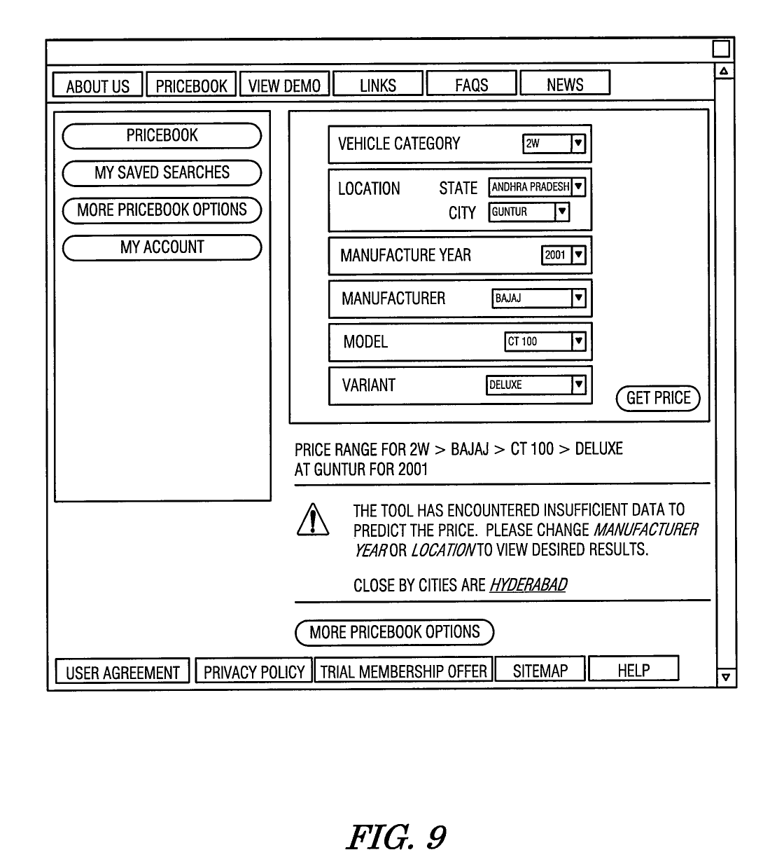

FIG. 9 illustrates another example user interface provided to a user when there are insufficient data points to predict or estimate a price. In the example shown in FIG. 9, the user is presented with the option to view results in cities near the location provided in the initial search parameters. Here, a nearby city is identified as Hyderabad and presented using a hyperlink. When the user activates the hyperlink, a price range for the selected vehicle is displayed.

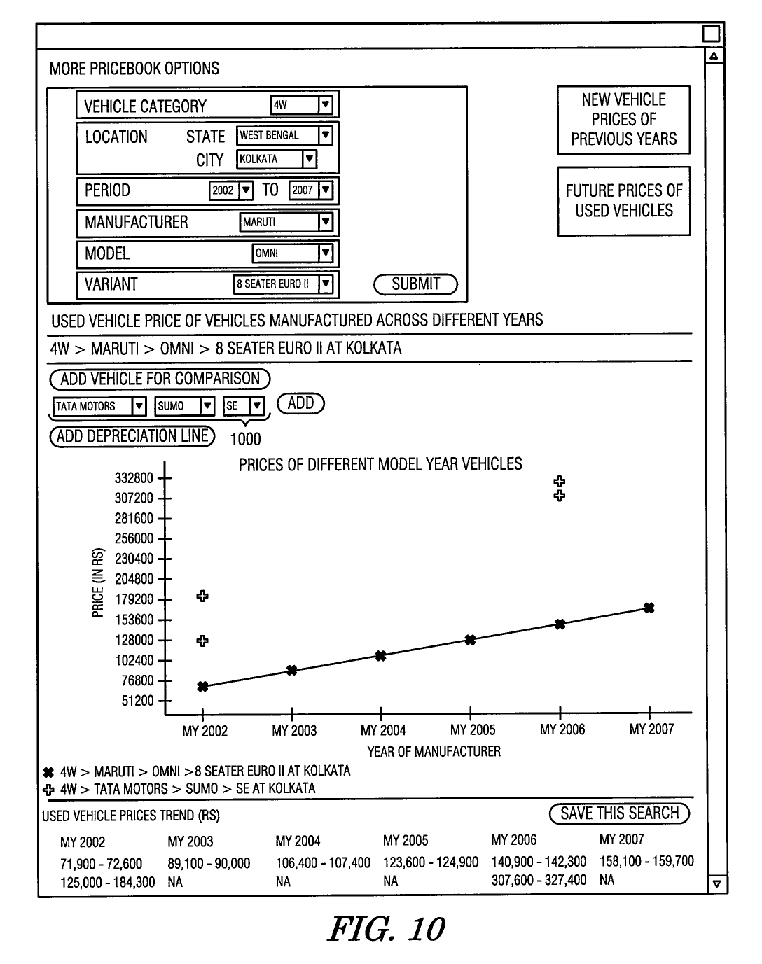

FIG. 10 illustrates an example user interface of a chart with two vehicles for comparison. In the example shown in FIG. 10, the user is initially presented the search parameter controls illustrated in FIG. 7 and obtains an initial search result (e.g., the MARUTI Omni). Using the add vehicle controls 1000, the user adds a Tata Motors Sumo to the chart and the prices for each vehicle are plotted to provide easy comparison.

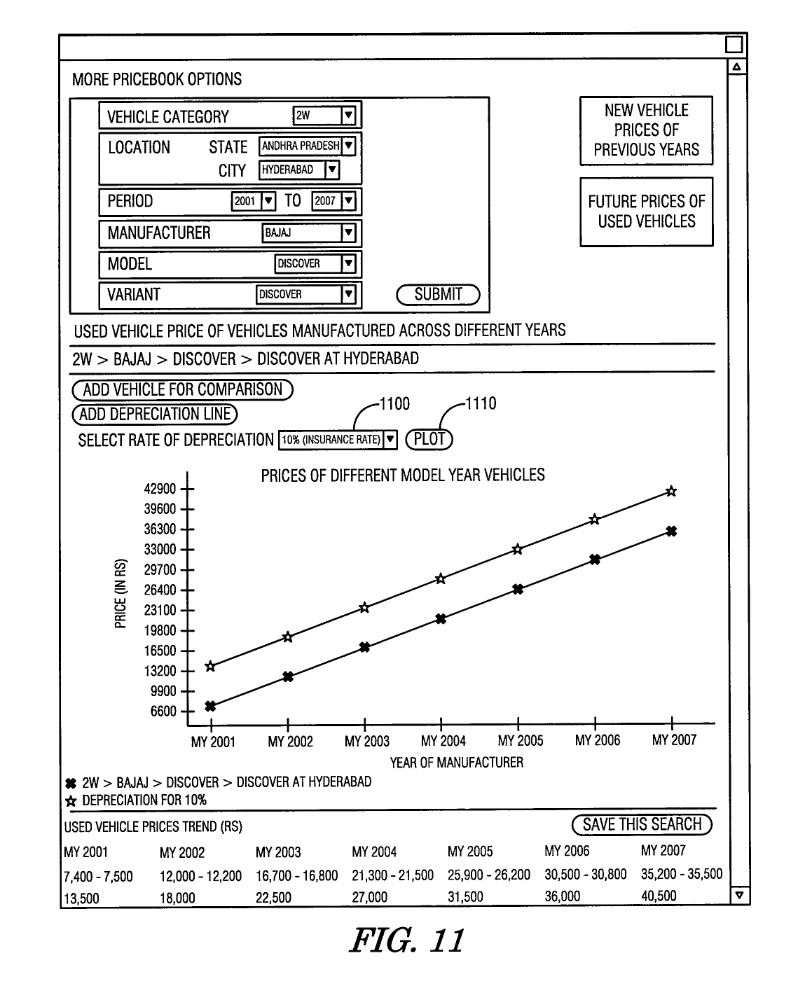

FIG. 11 illustrates an example user interface of a chart with a vehicle price and a depreciated residual price plotted together. In this example, the user may select a depreciation type (e.g., insurance or corporate) from the depreciation type control 1100 and then plot the depreciated values using the plot depreciation control 1110. In some example embodiments, the user may provide a depreciation amount or function to be used when calculating depreciation. In the example shown, the user has selected the insurance depreciation amount of 10% and the residual vehicle prices are plotted using this depreciation amount. Depreciation values maybe linear (e.g., 10%, 20%, $5000/year), logarithmic, or otherwise derived. In some instances, depreciation is standardized by a city, state, or federal governmental body. In other instances, depreciation is standardized by a public or private organization, such as an insurance industry coalition.

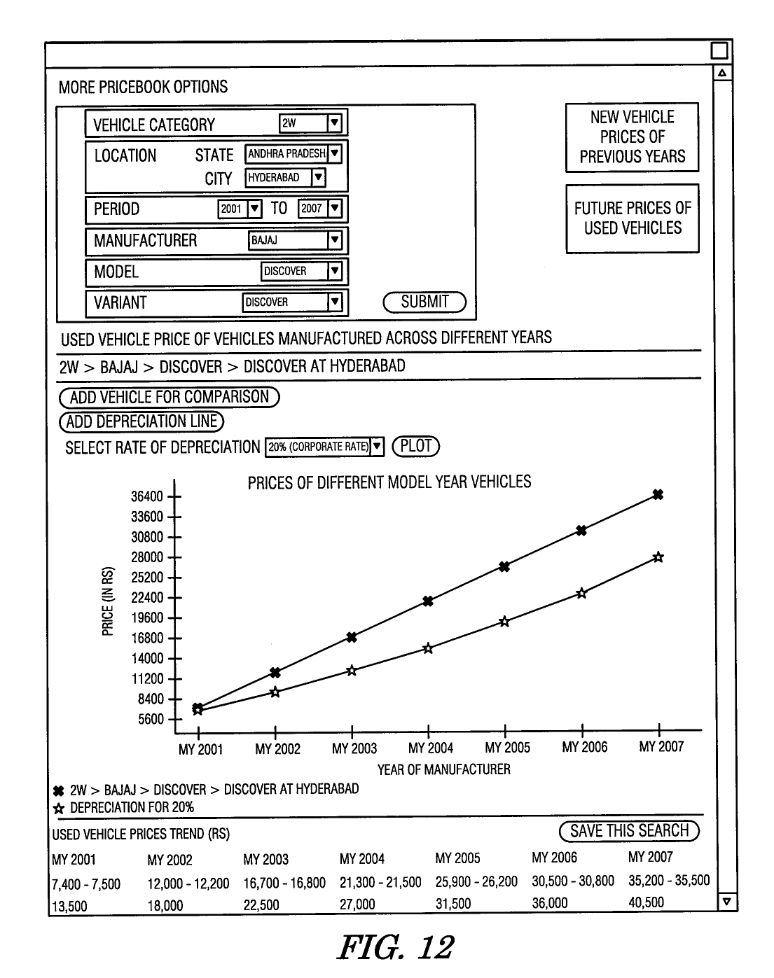

FIG. 12 illustrates another example user interface of a chart with a vehicle price and a depreciated residual price plotted together. The example shown in FIG. 11 illustrates depreciated residual values based on a corporate rate of depreciation of 20%, according to an example embodiment.

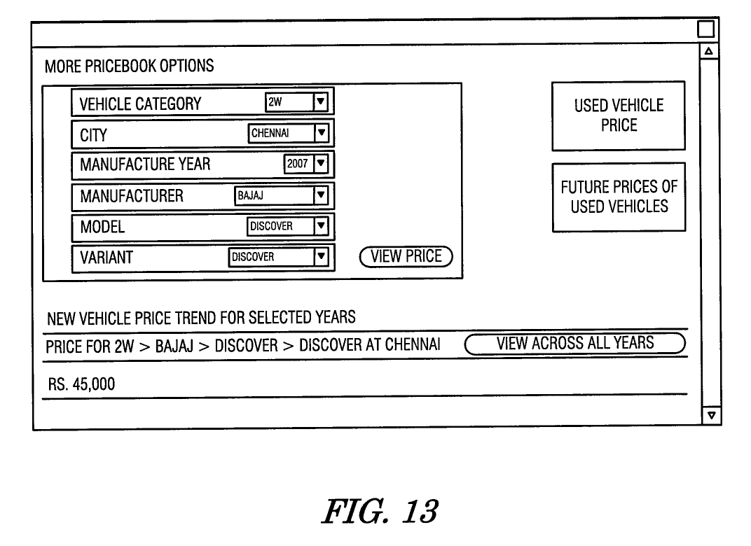

FIG. 13 illustrates an example user interface that provides the user a new vehicle price for a particular year.

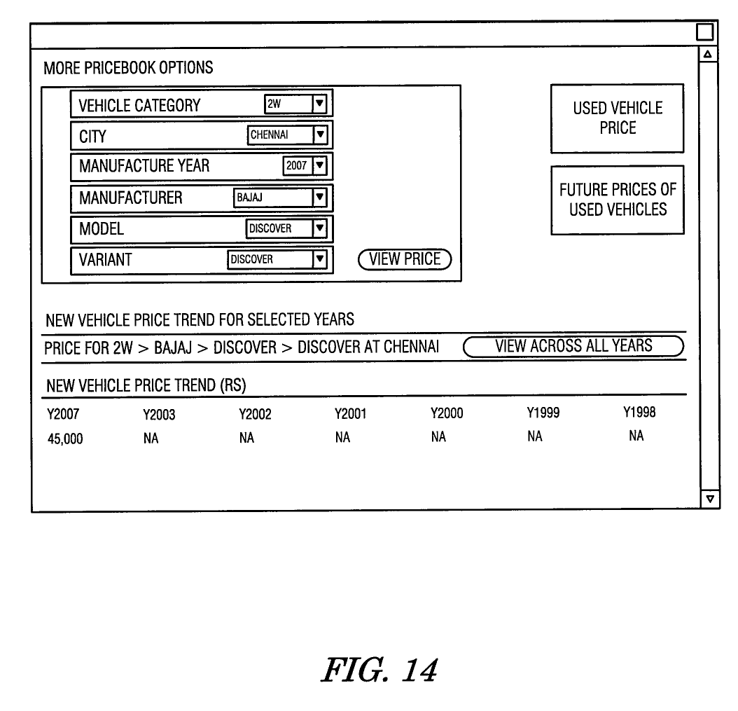

FIG. 14 illustrates an example user interface that provides the user a new vehicle price over a range of years. In the example shown, data is not available for several model years. In this case, the new vehicle price is represented with an “NA,” indicating that the vehicle price is not available. In some embodiments, the new vehicle price trend may be displayed or presented as a graph, chart, or other graphical representation.

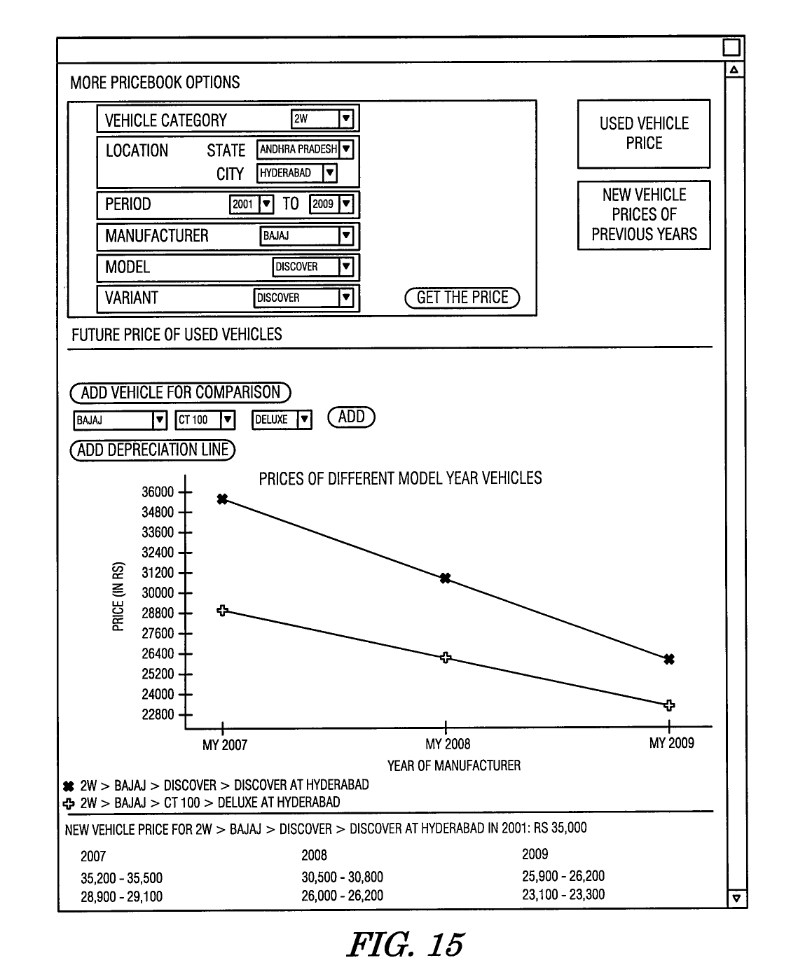

FIG. 15 illustrates an example user interface that provides an estimated future vehicle price. In the example shown in FIG. 15, a second comparison vehicle has been included in the chart. The estimated future vehicle price may also be referred to as an estimated residual value of a vehicle. The residual value may be calculated using statistical modeling, straight line depreciation (e.g., for standardized depreciation models), or with other calculations or estimations.

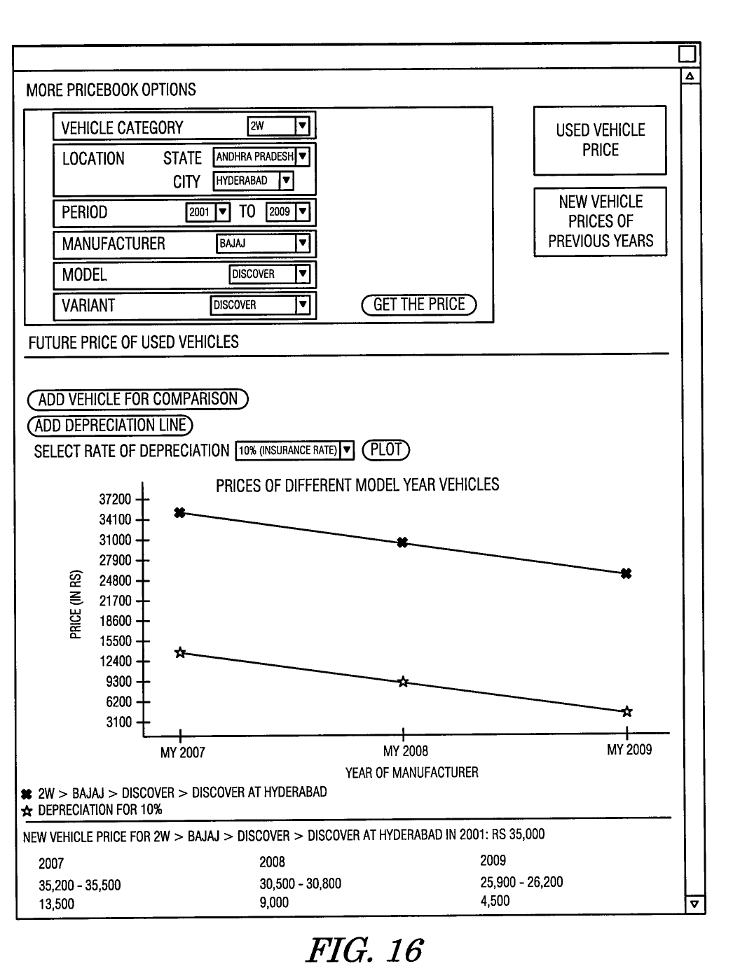

FIG. 16 illustrates an example user interface that provides an estimated future depreciation plotted against an estimated future price of a particular vehicle.

### Example Machine Architecture

FIG. 17 is a block diagram of machine in the example form of a computer system 1700 within which a set of instructions, for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU) a graphics processing unit (GPU) or both), a main memory 1704 and a static memory 1706, which communicate with each other via a bus 1708. The computer system 1700 may further include a video display unit 1710 (e.g., a liquid crystal display (LCD) or a cathode ray tube (CRT)). The computer system 1700 also includes an alphanumeric input device 1712 (e.g., a keyboard), a user interface navigation device 1714 (e.g., a mouse), a disk drive unit 1716, a signal generation device 1718 (e.g., a speaker) and a network interface device 1720.

The disk drive unit 1716 includes a machine-readable medium 1722 on which is stored one or more sets of instructions (e.g., software 1724) embodying any one or more of the methodologies or functions described herein. The software 1724 may also reside, completely or at least partially, within the main memory 1704 and/or within the processor 1702 during execution thereof by the computer system 1700, the main memory 1704 and the processor 1702 also constituting machine-readable media. The software 1724 may further be transmitted or received over a network 1726 via the network interface device 1720.

While the machine-readable medium 1722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, tangible media, such as solid-state memories, optical, and magnetic media.

Thus, a method and system to estimate vehicle prices have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
accessing vehicle auction transaction data from an online vehicle auction system, the vehicle auction transaction data including a first vehicle;
processing the vehicle auction transaction data to estimate a vehicle price;
storing the vehicle price in a database; and
presenting the vehicle price.

2. The computer-implemented method of claim 1, wherein the vehicle auction transaction data includes one or more of auction information, vehicle information, or transaction information.

3. The computer-implemented method of claim 2, wherein the auction information includes at least one of auction listing information, initial auction price, auction closing price, or auction transaction costs.

4. The computer-implemented method of claim 2, wherein the vehicle information includes at least one of a vehicle mileage, a vehicle condition, a vehicle manufacturer, a vehicle make, a vehicle model, a vehicle variant, a vehicle trim, a vehicle engine, or vehicle options.

5. The computer-implemented method of claim 2, wherein the transaction information includes at least one of a seller, a buyer, an auction closing price, a bid history, a tax, or a transaction surcharge.

6. The computer-implemented method of claim 1, wherein the processing of the vehicle auction transaction data further comprises:
determining a number of data points of vehicle sales of vehicles similar to the first vehicle;
estimating the vehicle price using a regression analysis when the number of data points is over a threshold amount; and
estimating the vehicle price using a mean analysis when the number of data points is under the threshold amount.

7. The computer-implemented method of claim 1, wherein the presenting the vehicle price further comprises:
presenting a first plot in a line graph, the first plot representing the vehicle price over time of the first vehicle; and
presenting a second plot in the line graph, the second plot representing a second vehicle price over time, the second vehicle price corresponding with a second vehicle, the second vehicle being a comparable vehicle to the first vehicle.

8. An online vehicle auction system comprising:
a storage device configured to store data related to a vehicle auction transaction;
a control device communicatively coupled to the storage device and configured to:
access the vehicle auction transaction data from the storage device, the vehicle auction transaction data including an first vehicle;
process the vehicle auction transaction data to estimate a vehicle price;
store the vehicle price in the storage device; and
present the vehicle price on a display device.

9. The system of claim 8, wherein the control device is further configured to:
determine a number of data points of vehicle sales of vehicles similar to the first vehicle;
estimate the vehicle price using a regression analysis when the number of data points is over a threshold amount; and
estimate the vehicle price using a mean analysis when the number of data points is under the threshold amount.

10. The system of claim 8, wherein the control device is further configured to:
present a first plot in a line graph, the first plot representing the vehicle price over time of the first vehicle; and
present a second plot in the line graph, the second plot representing a second vehicle price over time, the second vehicle price corresponding with a second vehicle,, the second vehicle being a comparable vehicle to the first vehicle.

11. A computer-implemented method comprising:
receiving an initial search parameter;
executing a first search of a vehicle database using the initial search parameter, the first search producing a first search result;
determining whether the first search result has at least a threshold number of search results;
when the first search result has at least the threshold number of search results, then presenting the search results; and
when the first search result has less than the threshold number of search results, then:
automatically determining a variant of the search parameter;
automatically executing a second search of the vehicle database using the variant of the search parameter, the second search producing a second search result; and
presenting the second search result to a user.

12. The computer-implemented method of claim 11, wherein the determining the variant of the search parameter further comprises:
determining a location associated with the initial search parameter;
calculating a second location in proximity to the location, the proximity based on a proximity setting; and
using the second location as the variant of the search parameter.

13. The computer-implemented method of claim 12, wherein the proximity setting is based on at least one of distance or a regional boundary.

14. The computer-implemented method of claim 11, wherein the determining of the variant of the search parameter further comprises:
determining an aspect of a vehicle associated with the initial search parameter;
identifying one or more similar vehicles based on the aspect of the vehicle associated with the initial search parameter; and
using at least one of the one or more similar vehicles as the variant of the search parameter.

15. The computer-implemented method of claim 14, wherein the aspect of the vehicle associated with the initial search parameter includes one or more of a vehicle classification, a vehicle type, a vehicle model, a vehicle trim, a vehicle segment, a vehicle use, a vehicle competitor, a vehicle price range, or vehicle options.

16. The computer-implemented method of claim 11, wherein the presenting of the second search result to the user further comprises:
presenting one or more locations, wherein each location corresponds to a subset search result in the second search result;
receiving a user-selected location from one or more locations; and
presenting the subset search result associated with the user-selected location.

17. The computer-implemented method of claim 16, wherein the location includes one of a city, a state, a region, or a province.

18. An online vehicle auction system comprising:
a storage device configured to store data related to vehicle auction transaction;
a control device communicatively coupled to the storage device and configured to:
receive an initial search parameter;
execute a first search of the storage device using the initial search parameter, the first search producing a first search result;
determine whether the first search result has at least a threshold number of search results;
when the first search result has at least the threshold number of search results, then present the search results; and
when the first search result has less than the threshold number of search results, then:
automatically determine a variant of the search parameter;
automatically execute a second search of the storage device using the variant of the search parameter, the second search producing a second search result; and
present the second search result to a user using a display device.

19. The system of claim 18, wherein the control device is further configured to:
determine a location associated with the initial search parameter;
calculate a second location in close proximity to the location based on a proximity setting; and
use the second location as the variant of the search parameter.

20. The system of claim 18, wherein the control device is further configured to:
determine an aspect of a vehicle associated with the initial search parameter;
identify one or more similar vehicles based on the aspect of the vehicle associated with the initial search parameter; and
use at least one of the one or more similar vehicles as the variant of the search parameter.

21. The system of claim 18, wherein the control device is further configured to:
present one or more locations, wherein each of the one or more locations corresponds to a subset search result in the second search result;
receive a user-selected location from the one or more locations; and
present the subset search result associated with the user-selected location.
